(19) United States
(12) Patent Application Publication
(10) Pub. No.: US 2014/0192287 A1
(43) Pub. Date: Jul. 10, 2014

(54) DISPLAY DEVICE

(71) Applicant: Samsung Display Co., Ltd, Yongin-City (KR)

(72) Inventors: Sang Youn HAN, Seoul (KR); Kyung Tea Park, Seoul (KR); Cheol Kyu Kim, Seoul (KR); Sung Hoon Yang, Seoul (KR); Sang Hyun Jeon, Gyeonggi-do (KR); Eun Jeong Cho, Busan (KR)

(73) Assignee: Samsung Display Co., Ltd, Yongin-City (KR)

(21) Appl. No.: 14/075,327

(22) Filed: Nov. 8, 2013

(30) Foreign Application Priority Data
Jan. 8, 2013 (KR) 10-2013-0002221

(51) Int. Cl. G02F 1/1368; G02F 1/1335

(52) U.S. Cl. CPC G02F 1/1368; G02F 1/1336
USPC 349/46

(57) ABSTRACT

A display device includes a display panel including a transistor and a backlight unit providing light to the display panel. The transistor includes a transparent substrate that the backlight unit faces. A gate electrode having a first width is disposed on the transparent substrate. A gate insulating layer, having a barrier layer, is disposed on the gate electrode and the transparent substrate. A semiconductor layer is disposed on the gate insulating layer. The semiconductor layer has a second width greater than the first width.

### CROSS-REFERENCE TO RELATED APPLICATION

This application claims priority under 35 U.S.C. §119 to Korean Patent Application No. 10-2013-0002221 filed on Jan. 8, 2013 in the Korean Intellectual Property Office, the disclosure of which is incorporated by reference herein in its entirety.

### TECHNICAL FIELD

The present invention relates to a display device.

### DISCUSSION OF RELATED ART

Display devices may be classified into self-emissive display devices displaying an image by self-emitting light and passive display devices displaying an image by controlling light emitted from a separate light source. Liquid crystal displays are classified as passive display devices.

Liquid crystal displays have two display panels and a backlight unit. Field generating electrodes such as a pixel electrode and a common electrode are formed on the two display panels and a liquid crystal layer is interposed between the panels. The backlight unit provides light to the liquid crystal layer. Voltages are applied to the field generating electrodes to generate an electric field across the liquid crystal layer. Liquid crystal molecules of the liquid crystal layer are aligned to the electric field. Accordingly, an emitting amount of the light provided from the backlight unit is controlled to display an image.

### SUMMARY

According to an exemplary embodiment of the present invention, a display device includes a display panel and a backlight unit providing light to the display panel. The display panel includes a substrate facing the backlight unit. A gate electrode is disposed on the substrate. A gate insulating layer is disposed on the gate electrode and the substrate. A semiconductor layer is disposed on the gate insulating layer. A barrier layer is inserted is the gate insulating layer, the barrier layer has larger band gap energy than the gate insulating layer, and light emitted from the backlight unit has luminance of equal to or more than 800 nit.

According to an exemplary embodiment of the present invention, a display device includes a backlight unit providing light having a predetermined luminance. A transparent substrate faces the backlight unit. A gate line is disposed on the transparent substrate. The gate line includes a gate line pad positioned at an end of the gate line and a gate electrode protruding upwardly from the gate line. A gate insulating layer, having a barrier layer, is disposed on the gate line and the transparent substrate. A semiconductor layer is disposed on the gate insulating layer. The barrier layer blocks carriers, injected from the gate electrode to the gate insulating layer, from forming traps at an interface between the semiconductor layer and the gate electrode.

According to an exemplary embodiment of the present invention, a display device includes a display panel accepting light. The display panel includes a substrate, a gate electrode disposed on the substrate, a gate insulating layer disposed on the gate electrode and the substrate, and a semiconductor layer disposed on the gate insulating layer. A barrier layer is inserted is the gate insulating layer, the barrier layer has larger band gap energy than the gate insulating layer. The light provided to the display panel has luminance of equal to or more than 800 nit.

### BRIEF DESCRIPTION OF THE DRAWINGS

These and other features of the present invention will become more apparent by describing in detail exemplary embodiments thereof with reference to the accompanying drawings of which:

FIG. 1 is a top plan view of a display device according to an exemplary embodiment of the present invention;

FIG. 2 is a cross-sectional view taken along lines II-II′ and II′-II″ of FIG. 1;

FIG. 3 is a cross-sectional view of a display device according to an exemplary embodiment of the present invention;

FIG. 4 is a cross-sectional view of a display device according to an exemplary embodiment of the present invention;

FIG. 5 is an energy band diagram showing a mechanism of how blackening deterioration occurs;

FIG. 6 shows a graph and a photo showing a transfer curved line when a blackening deterioration occurs;

FIG. 7 is an energy band diagram of a gate insulation layer when the gate insulation layer includes a barrier layer according to an exemplary embodiment of the present invention;

FIG. 8 is a graph showing a threshold voltage change value with the passage of time when a transistor includes a gate insulating layer according to an exemplary embodiment;

FIG. 9 is a graph showing a threshold voltage change value according to a thickness of a barrier layer according to an exemplary embodiment of the present invention;

FIG. 10A is a graph showing a threshold voltage change value when a gate insulating layer includes no barrier layer, and

FIG. 10B is a graph showing a threshold voltage change value when a gate insulating layer includes a barrier layer including silicon oxide with a thickness of 300 Å.

### DETAILED DESCRIPTION OF THE EMBODIMENTS

Exemplary embodiments of the present invention will be described below in more detail with reference to the accompanying drawings. However, the present invention may be embodied in different forms and should not be construed as limited to the embodiments set forth herein.

In the drawings, the thickness of layers, films, panels, regions, etc., may be exaggerated for clarity. It will be understood that when an element such as a layer, film, region, or substrate is referred to as being “on” another element, it may be directly on the other element or intervening elements may also be present. Like reference numerals may refer to like elements throughout the specification and drawings.

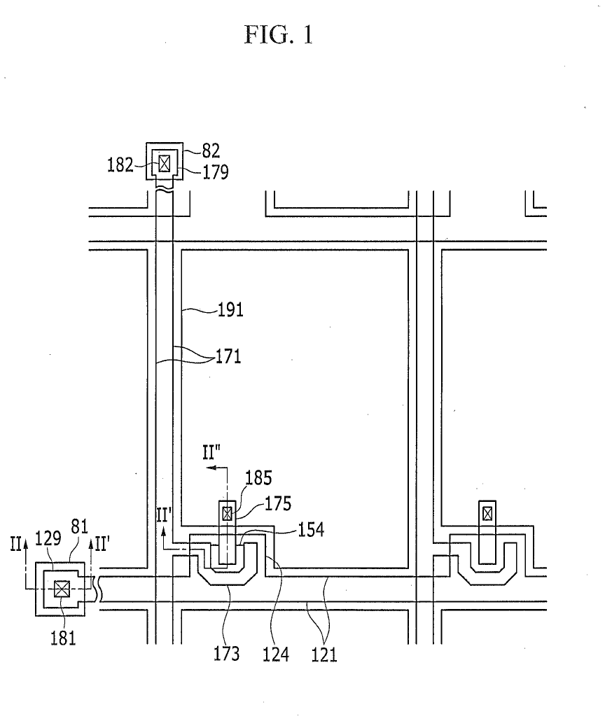

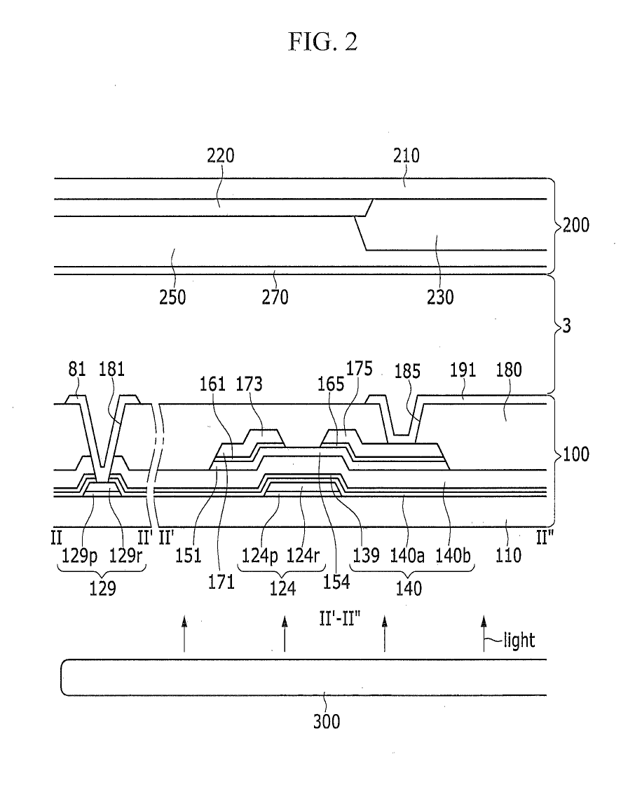

FIG. 1 is a top plan view of a display device according to an exemplary embodiment of the present invention. FIG. 2 is a cross-sectional view taken along lines II-II′ and II′-II″ of FIG. 1.

Referring to FIG. 1 and FIG. 2, a display device according to an exemplary embodiment includes a lower panel 100, an upper panel 200, and a liquid crystal layer 3 interposed between the two display panels 100 and 200. A backlight unit 300 is disposed to face the lower panel 100. In an exemplary embodiment, the lower panel 100 is include in a liquid crystal display device, but the lower panel may also be applied to other display devices using the backlight unit 300. In an exemplary embodiment, the backlight unit 300 may be disposed at a position facing the upper panel 200.

Firstly, the lower panel 100 will be described.

A gate line 121 is formed on the insulation substrate 110. The gate line 121 may include transparent glass and/or plastic.

The gate line 121 transmits a gate signal and extends in a transverse direction. A gate line 121 includes a gate electrode 124 protruding upwardly and a gate line pad 129 for connection with another layer or a gate driver (not shown).

The gate line 121 has a dual-layered structure. For example, the gate electrode 124 has a lower layer 124p and an upper layer 124r. The lower layer 124p may include titanium, tantalum, molybdenum, or an alloy thereof. The upper layer may include copper (Cu) or a copper alloy. Alternatively, the gate line 121 may include a single-layered structure.

A gate insulating layer 140 is formed on the gate line 121. The gate insulating layer 140 is multi-layered. For example, the gate insulating layer 140 includes a lower gate insulating layer 140a, an upper gate insulating layer 140b, and a barrier layer 139 disposed therebetween. The lower gate insulating layer 140a may include an insulating material such as silicon nitride to prevent the gate electrode 124 from being oxidized. The lower gate insulating layer 140a may include a thickness of about 100 Å.

The upper gate insulating layer 140b may include an insulating material such as silicon nitride to prevent a semiconductor layer 151 from reacting with oxygen to deteriorate a characteristic thereof.

The barrier layer 139 may include a material having a smaller dielectric constant and larger band gap energy than that of a material forming the first and the second gate insulating layers 140a and 140b. For example, when the first and the second gate insulating layers include silicon nitride, the barrier layer 139 may include silicon oxide.

In an exemplary embodiment, a thickness of the barrier layer 139 may range from about 100 Å to about 1800 Å. Without the barrier layer 139, the gate insulating layer 140, when made of only silicon nitride, may have a thickness about 4000 Å, and the gate insulating layer 140 has greater gap energy than that of a material forming the lower gate insulating layer 140a. Accordingly, the barrier layer 139 may have a same effective thickness with half of the thickness of silicon nitride layer, and thus the gate insulating layer 140 may has less thickness than where a gate insulating layer includes only silicon nitride.

A semiconductor layer 154 is formed on the gate insulating layer 140. The semiconductor layer 154 may include amorphous silicon, polysilicon, hydrogenated amorphous or hydrogenated polysilicon. The semiconductor layer 154 is overlapped with the gate electrode 124 and further includes a portion 151 laterally extended away from the overlapped semiconductor layer 154. Alternatively, the semiconductor layer need not include the extended portion 151.

Ohmic contact layers 161 and 165 are disposed between the semiconductor layer 154 and a source electrode 173 and between the semiconductor layer 154 and a drain electrode 175, respectively. For example, the source electrode 173 is disposed on the ohmic contact layer 161, and the drain electrode 175 is disposed on the ohmic contact layer 165.

The source electrode 173 having a U-shape is connected to a data line 171 and partially surrounds the drain electrode 175.

The data lines 171 may transmit data signals, extending in a vertical direction to cross the gate line 121. The source electrode 173 having a U-shape extends toward the gate electrode 124 from the data line 171. The present invention is not limited thereto, but the source electrode may have various shapes.

The drain electrode 175 is separated from the data line 171 and is extended upwardly from the center of the U shape of the source electrode 173. The data line 171 includes an end portion 179 having a wide area for connection with another layer or a data driver (not shown).

Although not shown, the data line 171, the source electrode 173, and the drain electrode 175 may include a dual-layer structure. For example, the data line 171 and the source and drain electrode 173 and 175 may include an upper layer and a lower layer. The upper layer may include copper (Cu) or a copper alloy, and the lower layers may include titanium (Ti), tantalum (Ta), molybdenum (Mo), or an alloy thereof.

The data line 171, the source electrode 173, and the drain electrode 175 may have a tapered sidewall.

The ohmic contact layer 161 is disposed between the semiconductor layer 151 and the data line 171 and between the semiconductor layer 151 and the source electrode 173. The ohmic contact 165 is disposed between the semiconductor layer 151 and the drain electrode 175. The ohmic contact layers 161 and 165 serve to reduce contact resistance therebetween. Further, the ohmic contacts 161 and 165 have substantially the same planar pattern as the data line 171, the source electrode 173, and the drain electrode 175.

The semiconductor layer 154 is partially covered with the ohmic contacts 161 and 165, and the semiconductor layer 154 is partially exposed between the source electrode 173 and the drain electrode 175.

A thin film transistor (TFT) may include a gate electrode 124, a source electrode 173, a drain electrode 175, and a semiconductor layer 154. The semiconductor layer 154 may include a channel (not shown) disposed between the source electrode 173 and the drain electrode 175.

A passivation layer 180 is disposed on the data line 171, the drain electrode 175, and the exposed portion of the semiconductor layer 154. The passivation layer 180 may include an inorganic insulator such as silicon nitride, silicon oxide, an organic insulator, or a low dielectric insulator.

A contact hole 181 penetrates the passivation layer 180 and the gate insulating layer 140 to expose the gate line pad 129 of the gate line 121. A contact hole 182 penetrates the passivation layer 180 to expose the end portion 179 of the data line 171. A contact hole 185 penetrates the passivation layer 180 to expose a distal end of the drain electrode 175 from the center of the U-shaped source electrode 173.

A pixel electrode 191 and contact assistants 81 and 82 are formed on the passivation layer 180. The electrode 191 and the contact assistants 81 and 82 may include a transparent conductive material such as indium tin oxide (ITO) and/or indium zinc oxide (IZO), or a reflective metal such as aluminum, silver, chromium, and/or an alloy thereof.

The pixel electrode 191 is physically and electrically connected to the drain electrode 175 through the contact hole 185, and may be supplied with a data voltage from the drain electrode 175.

The contact assistants 81 and 82 are connected to the gate line pad 129 of the gate line 121 and the data line 171 through the contact holes 181 and 182, respectively. The contact assistants 81 and 82 serves as adhesion layers between the gate line pad 129 of the gate lines 121 and an external apparatus and between the end portion 179 of the data line 171 and an external apparatus, respectively. The contact assistants 81 and 82 further serve to protect the gate line pad 129 and the end portion 179.

Next, the upper panel 200 will be described.

A light blocking member 220 is formed on an insulation substrate 210 of transparent glass or plastic. The light blocking member 220 prevents light leakage between the pixel electrodes 191.

A color filter 230 is disposed on the substrate 210. The color filter is also partially disposed on an edge portion of the light blocking member 220. For example, the color filter 230 is mostly disposed in the region enclosed by the light blocking member 220, and may extend along a column of the pixel electrodes 191. The color filter 230 may display one of three primary colors such as red, green, or blue.

In an exemplary embodiment, the light blocking member 220 and the color filter 230 are disposed in the upper panel 100. The present invention is not limited thereto, but the light blocking member 200 and/or the color filter 230 may be disposed in the lower panel 200.

An overcoat 250 is disposed on the color filter 230 and the light blocking member 220. The overcoat 250 may include an (organic) insulator. The overcoat 250 may prevent the color filter 230 from being exposed. The overcoat 250 provides a flat surface. Alternatively, the overcoat 250 may be omitted.

A common electrode 270 is disposed on the overcoat 250. The common electrode 270 may include a transparent conductive material, such as ITO and IZO, and may receive the common voltage Vcom.

The liquid crystal layer 3 disposed between the lower panel 100 and the upper panel 200 may have negative dielectric anisotropy where liquid crystal molecules of the liquid crystal layer 3 tend to be oriented almost perpendicular to the electric field applied. For example, the liquid crystal molecules are oriented almost perpendicular to the electric field induced between the surfaces of the two display panels 100 and 200.

The pixel electrode 191, overlapped with the common electrode 270, constitutes a liquid crystal capacitor (not shown) along with the liquid crystal layer 3 therebetween. The liquid crystal capacitor serves to store a voltage applied to the liquid crystal capacitor. For example, when a voltage is turned off, the stored voltage is maintained and applied to the liquid crystal layer 3.

The pixel electrode 191 may further constitute a storage capacitor (not shown), connected in parallel to the liquid crystal capacitor (not shown), by overlapping a storage electrode line (not shown). Accordingly, the storage capacitor may improve a voltage maintenance capability of a liquid crystal capacitor.

In an exemplary embodiment, the backlight unit 300 may have high luminance for high brightness of a display device. For example, the backlight unit 300 may have luminance greater than about 800 nit. A display device according to an exemplary embodiment of the present invention may include a digital information display used in a public place such as an airport or a terminal.

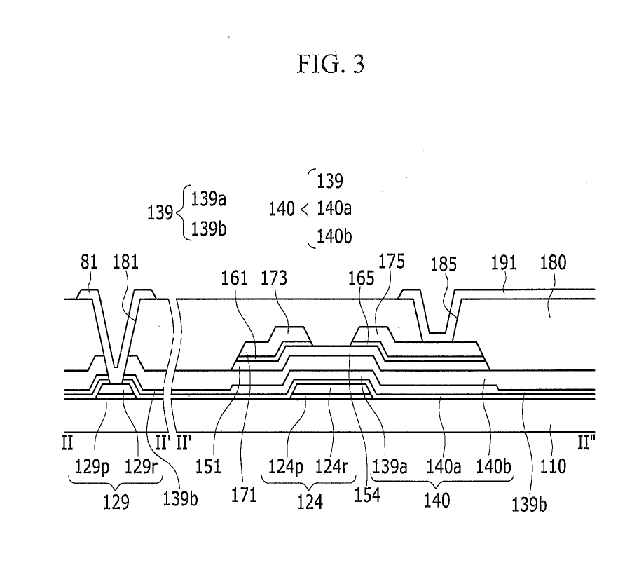

FIG. 3 is a cross-sectional view of a lower panel according to an exemplary embodiment of the present invention. The lower panel of FIG. 3 is substantially similar to that of FIG. 2, except the barrier layer 139.

Referring to FIGS. 1 and 3, the lower panel is substantially similar to the exemplary embodiment as shown in FIG. 2, except the barrier layer 139. The barrier layer 139 includes a first barrier layer 139a and a second barrier layer 139b. The first barrier layer 139a is disposed on the semiconductor layer 154. The second barrier layer 139b may be disposed at a portion not corresponding to the semiconductor layer 154. For example, the second barrier layer 139b is disposed on the gate line pad 129 of the gate line 121. Here, the first barrier layer 139a is thicker than the second barrier layer 139b. If the first barrier layer 139a is thicker, the effect of preventing the blackening deterioration is further increased.

A contact hole 181 penetrates the second barrier layer 139b. When the barrier layer 139 is included in the gate insulating layer 140, the thinner barrier layer 139b does not increase the aspect ratio of the contact hole 181 to such an extent that such aspect ratio increase makes forming of the contact hole 181 more difficult than when the gate insulating layer 140 includes no barrier layer 139. The barrier layer 139 may include silicon oxide. Accordingly, in an exemplary embodiment, the thickness of the second barrier layer 139b may be relatively thinly formed.

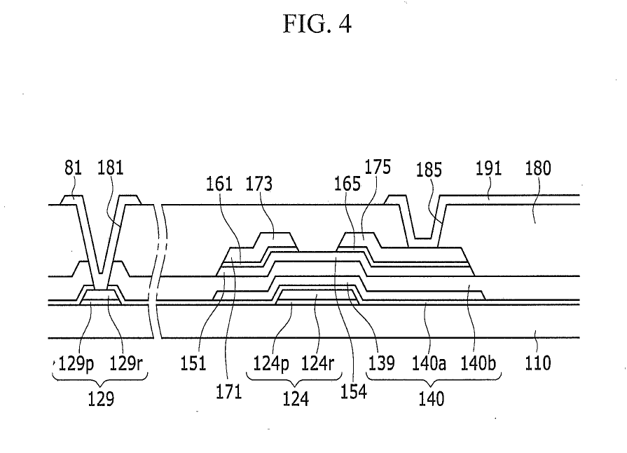

FIG. 4 is a cross-sectional view of a display device according to an exemplary embodiment of the present invention. The lower panel of FIG. 4 is substantially similar to that of FIG. 2, except the barrier layer 139.

Referring to FIGS. 1 and 4, the barrier layer 139 is disposed on the semiconductor layer 154, and the barrier layer 139 is not formed on the gate line pad 129 of the gate line 121. Here, the inclusion of the barrier layer into the gate insulating layer 140 does not increase the aspect ratio of the contact hole 181.

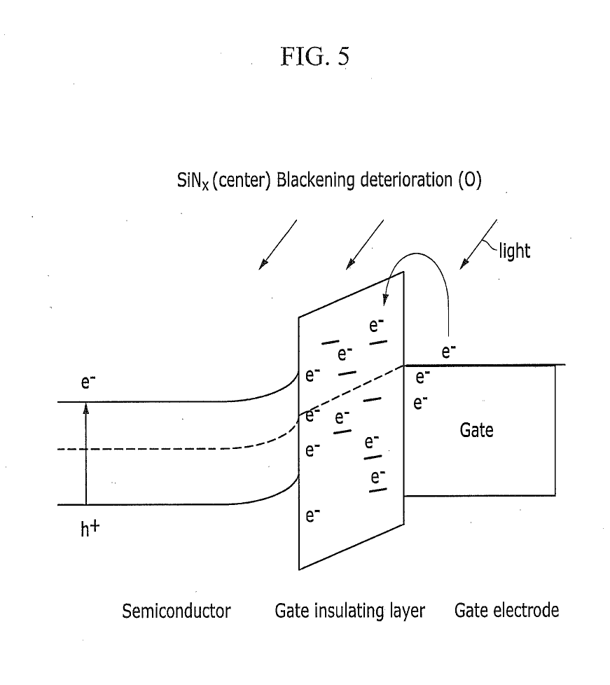

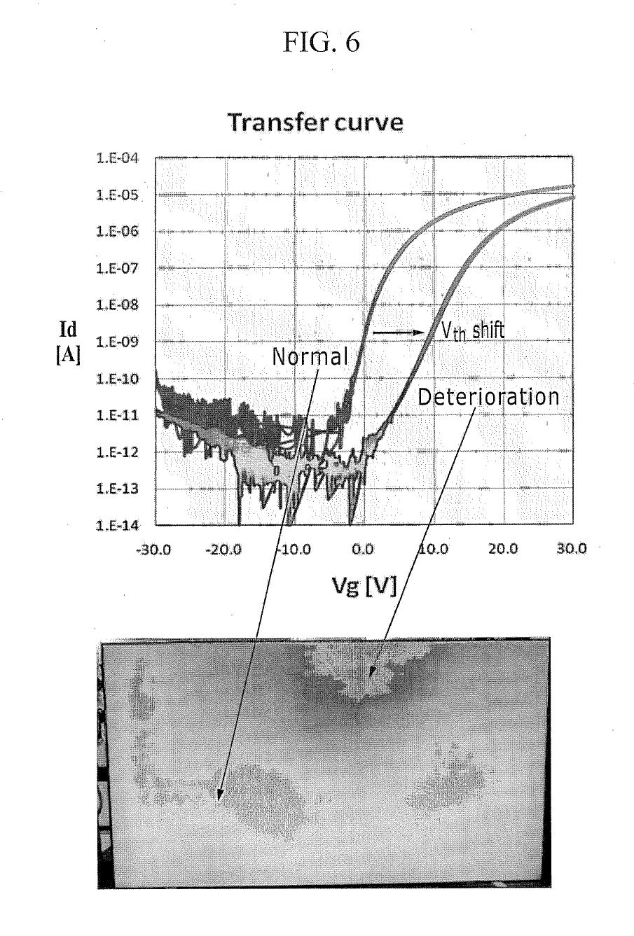

FIG. 5 is an energy band diagram showing a mechanism showing how a blackening deterioration occurs. FIG. 6 shows a photo example of a blackening deterioration and a I-V curve showing a Vth shift when a blackening deterioration occurs.

Referring to FIG. 5, an energy band diagram formed by a gate electrode, a gate insulating layer, and a semiconductor layer is shown when a negative voltage is applied to the gate electrode. When a backlight unit provides light having luminance greater than 800 nit, the light may assist electrons generated by a negative voltage applied through the gate electrode to be injected into the gate insulating layer to form a trap on an interface between the semiconductor layer and the insulating layer.

Referring to FIG. 6, a curved line of a gate voltage (Vg)-a drain current (Id) is shifted to the right side by the electron trap as described above. Fog a given gate voltage (Vg), this shift causes the drain current (Id) to be reduced compared to a normal Vg-Id curve. Accordingly, in a normally black mode, a blackening may occur where a display mode changes from a gate-on state to a white state. For example, a dark region appears, as shown in the photo example of the FIG. 6, in a display.

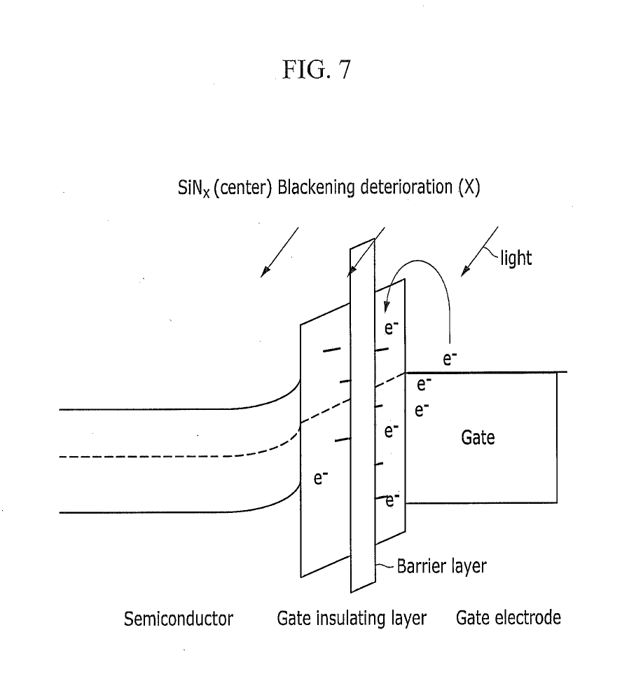

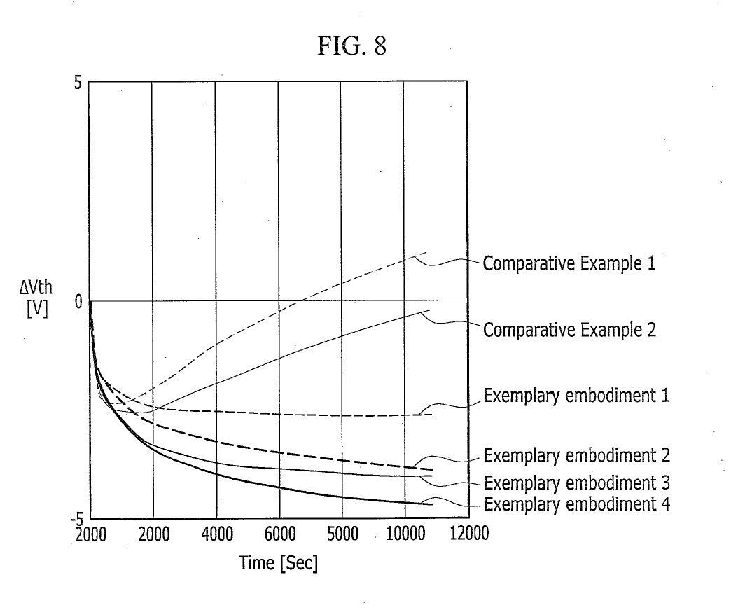

FIG. 7 is an energy band diagram showing a mechanism preventing a blackening deterioration in a display device according to an exemplary embodiment of the present invention. FIG. 8 is a graph showing a threshold voltage change value with the passage of time when a transistor includes a gate insulating layer according to an exemplary embodiment.

Referring to FIG. 7, an insulating layer according to an exemplary embodiment of the present invention includes barrier layer having a large band gap energy to block electrons generated by the negative voltage from being photo-assisted injected into the interface between the semiconductor layer and the insulating layer.

Referring to FIG. 8, a threshold voltage change value (ΔVth) is shown with the passage of time. To show the effect of the present invention, comparative examples Comparative Example 1 and Comparative Example 2 are shown as well. The comparative examples Comparative Example 1 and Comparative Example 2 include a gate insulating layer without a barrier layer. As to the comparative examples, a threshold voltage change value (ΔVth) changes from a negative value to a positive value with the passage of time. In contrast, exemplary embodiments Exemplary Embodiment 1 to Exemplary Embodiment 4 according to the present invention show a threshold voltage change value (ΔVth) that continues to be a negative value with the passage of time and thus the blackening deterioration does not occur. Further, the negative threshold voltage change value may shift the curved line of Vg-Id to the left side of the normal Vg-Id curve.

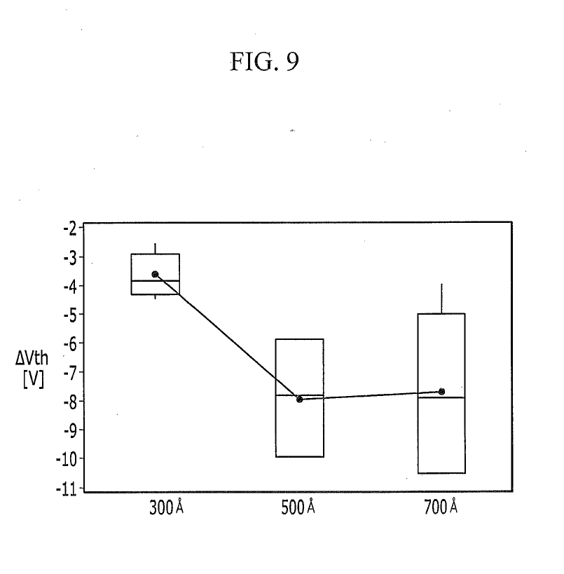

FIG. 9 is a graph showing a threshold voltage change value according to a thickness of a barrier layer of a gate insulating layer according to an exemplary embodiment of the present invention.

Referring to FIG. 9, a threshold voltage change value is measured by forming the barrier layer with thickness of 300 Å, 500 Å, and 700 Å, respectively. The blackening deterioration preventing effect increases as the thickness of the barrier layer increases. For example, the barrier layer with a thickness of 500 Å has greater effects in blocking the photo-assisted injection compared with the barrier layer with 300 Å.

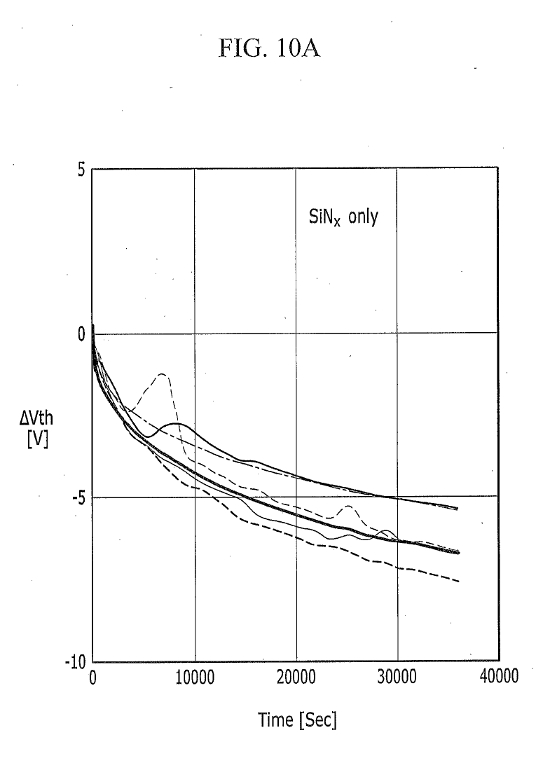

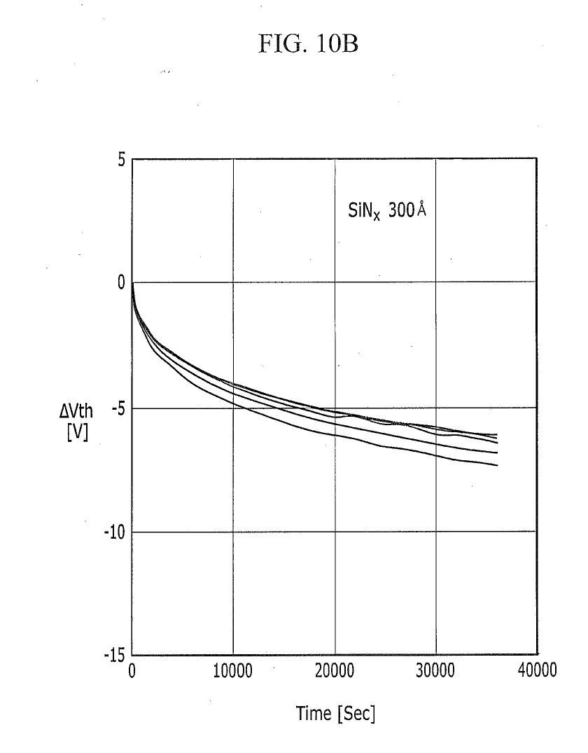

FIG. 10A is a graph showing a threshold voltage change value when a gate insulating layer includes no barrier layer. FIG. 10B is a graph showing a threshold voltage change value when a gate insulating layer includes a barrier layer including silicon oxide with a thickness of 300 Å.

FIGS. 10A and 10B show reliability of a thin film transistor in a gate-off state to estimate a leakage current.

Referring to FIG. 10A, a gate insulating layer, as a comparative sample, includes silicon nitride only. The negative threshold voltage change value (ΔVth) may shift a curved line Vg-Id to the left side of a normal Vg-Id curve. The Vg-Id curve decreases with the passage of time with unstable fluctuation. Referring to FIG. 10B, a gate insulating layer having a barrier layer including a material having a large band gap energy such as silicon oxide with the thickness of 300 Å has a Vg-Id curved line which decreases similar to that of FIG. 10A, but has less fluctuation than that of FIG. 10A.

In this way, the barrier layer with the thickness of 300 Å reduces a leakage current while prevents the blackening deterioration from occurring.

While the present inventive concept has been shown and described with reference to exemplary embodiments thereof, it will be apparent to those of ordinary skill in the art that various changes in form and detail may be made therein without departing from the sprit and scope of the inventive concept as defined by the following claims.

What is claimed is:

1. A display device comprising:
a display panel and
a backlight unit providing light to the display panel,
wherein the display panel includes
a substrate that the backlight unit faces,
a gate electrode disposed on the substrate,
a gate insulating layer disposed on the gate electrode and the substrate, and
a semiconductor layer disposed on the gate insulating layer,
wherein a barrier layer is inserted in the gate insulating layer, the barrier layer having larger band gap energy than the gate insulating layer, and
wherein light emitted from the backlight unit has luminance of equal to or more than 800 nit.

2. The display device of claim 1, wherein the gate insulating layer further includes a first insulating layer and a second insulating layer, and
wherein the first insulating layer is disposed on the gate electrode, the barrier layer is disposed on the first insulating layer, and the second gate insulating layer is disposed on the barrier layer.

3. The display device of claim 2, wherein a dielectric constant of the barrier layer is about half of a dielectric constant of the first gate insulating layer.

4. The display device of claim 3, wherein the first gate insulating layer or the second insulating layer includes silicon nitride, and the barrier layer includes silicon oxide.

5. The display device of claim 3, wherein a thickness of the barrier layer ranges about 100 Å to about 700 Å.

6. The display device of claim 1, wherein the semiconductor layer includes amorphous silicon.

7. The display device of claim 1, wherein the barrier layer includes a first part and a second part, wherein the first part of the barrier layer is overlapped with the semiconductor layer and is thicker than the second part.

8. The display device of claim 7, further comprising:
a contact hole penetrating the second part of the barrier layer.

9. The display device of claim 8, further comprising:
a gate line including a gate line pad and the gate electrode,
wherein the gate line extends in a transverse direction, the gate line pad is positioned at an end of the gate line, and the gate electrode protrudes upwardly from the gate line, and
wherein the contact hole exposes a portion of the gate line pad.

10. The display device of claim 2, wherein the barrier layer is formed with an island shape at a portion corresponding to the semiconductor layer.

11. The display device of claim 1, wherein the display panel further includes a liquid crystal layer.

12. A display device comprising:
a backlight unit providing light having a predetermined luminance;
a transparent substrate facing the backlight unit;
a gate line disposed on the transparent substrate, wherein the gate line includes a gate line pad positioned at an end of the gate line and a gate electrode protruding upwardly from the gate line;
a gate insulating layer, having a barrier layer, disposed on the gate line and the transparent substrate;
a semiconductor layer disposed on the gate insulating layer,
wherein the barrier layer blocks carriers injected from the gate electrode to the gate insulating layer from forming traps at an interface between the gate electrode and the semiconductor layer.

13. The display device of claim 12, wherein the wherein the gate insulating layer further includes a first insulating layer and a second insulating layer,
wherein the first insulating layer is disposed on the gate electrode, the barrier layer is disposed on the first insulating layer, and the second gate insulating layer is disposed on the barrier layer, and
wherein the barrier layer has a band gap energy greater than the first insulating layer.

14. The display device of claim 12, wherein the barrier layer includes a first part and a second part, wherein the first part overlaps the gate electrode and the first part is thicker than the second part.

15. The display device of claim 14, further comprising a contact hole penetrating the second part of the barrier layer to expose a portion of the gate line pad.

16. The display device of claim 14, wherein the semiconductor layer having a first width overlaps the barrier layer having a second width,
wherein the first width is substantially equal to the second width.

17. The display device of claim 16, wherein the second insulating layer covers the barrier layer and the first insulating layer.

18. The display device of claim 17, further comprising a contact hole penetrating the second insulating layer and the first insulating layer covered with the second insulating layer to expose a portion of the gate electrode.

19. The display device of claim 12, wherein the predetermined luminance of the backlight unit is greater than about 800 nit.

20. A display device comprising:
a display panel accepting light,
wherein the display panel includes
a substrate,
a gate electrode disposed on the substrate,
a gate insulating layer disposed on the gate electrode and the substrate, and
a semiconductor layer disposed on the gate insulating layer,
wherein a barrier layer is inserted is the gate insulating layer, the barrier layer has larger band gap energy than the gate insulating layer, and
wherein the light provided to the display panel has luminance of equal to or more than 800 nit.
